(19) United States
(12) Patent Application Publication
(10) Pub. No.: US 2014/0279869 A1
(43) Pub. Date: Sep. 18, 2014

(54) Transaction-Based Traversal-Free Data Synchronization Among Multiple Sites

(71) Applicants: Chen-Yu Wu, Cypress, CA (US); Reiner K. Kaiser, Redondo Beach, CA (US)

(72) Inventors: Chen-Yu Wu, Cypress, CA (US); Reiner K. Kaiser, Redondo Beach, CA (US)

(73) Assignee: Siemens Product Lifecycle Management Software Inc., Plano, TX (US)

(21) Appl. No.: 13/795,422

(22) Filed: Mar. 12, 2013

(51) Int. Cl. G06F 17/30

(52) U.S. Cl. CPC G06F 17/30575
USPC 707/610

(57) ABSTRACT

A PDM system, method, and computer program product for data transfer. A method includes determining a plurality of persistent objects in a data structure to be replicated to a plurality of replication sites. The plurality of persistent objects is identified based on a transaction table entry identifying a specific scoped transaction. The method includes determining specific persistent objects of the plurality of persistent objects to be replicated to each of the plurality of replication sites based on which of the plurality of persistent objects have been updated since last being replicated to each respective replication site, without traversing the full data structure. The method includes initiating a synchronization transaction according to the specific persistent objects and replicating the specific persistent objects to at least one of the plurality of replication sites, without traversing the full data structure.

### CROSS-REFERENCE TO OTHER APPLICATIONS

The present application has some subject matter in common with, but is not necessarily otherwise related to commonly-assigned U.S. Pat. Nos. 8,332,358 and 8,332,420, incorporated by reference herein. Commonly-assigned U.S. Patent Applications 61/292,186 (filed Jan. 5, 2010), Ser. No. 12/690,188 (filed Jan. 20, 2010), Ser. No. 13/418,424 (filed Mar. 13, 2012), and Ser. No. 13/418,433 (filed Mar. 13, 2012) are also incorporated by reference herein.

### TECHNICAL FIELD

The present disclosure is directed, in general, to data management systems and methods, including computer-aided design, visualization, and manufacturing systems, product lifecycle management (“PLM”) systems, and similar systems, that manage data for products and other items (collectively, “Product Data Management” systems or PDM systems).

### BACKGROUND OF THE DISCLOSURE

PDM systems manage PLM and other data. Improved systems are desirable.

### SUMMARY OF THE DISCLOSURE

Various disclosed embodiments include a system, method, and computer program product for data transfer. The method includes determining a plurality of persistent objects in a data structure to be replicated to a plurality of replication sites. The plurality of persistent objects is identified based on a transaction table entry identifying a specific scoped transaction. The method includes determining specific persistent objects of the plurality of persistent objects to be replicated to each of the plurality of replication sites based on which of the plurality of persistent objects have been updated since last being replicated to each respective replication site, without traversing the full data structure. The method includes initiating a synchronization transaction according to the specific persistent objects and replicating the specific persistent objects to at least one of the plurality of replication sites, without traversing the full data structure.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software, or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a block diagram of a data processing system in which an embodiment can be implemented;

FIG. 2 illustrates a simplified block diagram of various data structures and relations that can be used in accordance with disclosed embodiments; and

FIG. 3 illustrates a flowchart of a process, in accordance with disclosed embodiments for performing a synchronization in a PDM data processing system.

### DETAILED DESCRIPTION

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Many data management systems, including PDM systems, have to support an ever-increasing data model, supporting more and more applications, many of which manage data heavily customized by individual customers or users. Objects in the data model can be continually updated or otherwise modified, and these updates must be synchronized, backed up, or otherwise processed. Conventional techniques require traversing the entire data structure to identify the elements that have been updated. Each object can represent a part, assembly, option, configuration, component, or other element in the data model.

Configuration and traversal of large data structures such as PDM bill-of-material (BOM) structures and other structures is complex and consumes significant time and memory. In many cases, downstream applications consume such structures and construct their own data models and processes based on the content of such structures. It is crucially important to keep such downstream data and processes up to date with respect to any evolving changes of the master structure.

Conventionally, identification of such changes of a structure on a periodic basis, such as hourly or nightly, has been conducted by re-traversing the structure top to bottom, and analyzing changes of individual constituents of that structure by comparing their time stamps of latest changes with the last time such analysis was performed.

In general, it is not possible to derive from the state of a parent object whether any of its child objects and subsequent referencers require updating. Therefore, this traversal approach is usually expensive with effort more or less proportional to the size of the structure and not the size of the change (which can be very small or even non-existent). In general, only a small percentage of the entire structure changes on a nightly basis, and it is those changes that must be identified and synchronized in the most efficient manner possible.

In the current PLM data exchange domain, once the product lifecycle data is replicated to multiple sites, in order to synchronize the modified data, the system has to traverse the entire previously-replicated data structure, compare the last save date (LSD) of each object with the last export date (LED) of its correspondent export record. The export record has the information about the replicated object, such as last export date, target site, and the correspondent exported object. The system can then replicate only the create/delete/modified candidates to the target sites.

Re-traversing the whole data structure is an expensive operation. In the example of a product structure with 1,000 objects, if only two objects were modified, current synchronization algorithms require a full re-traverse in order to just find the two modified objects. The effort of finding update candidates is proportional to the size of the structure instead of the size of the change.

In the above example, if the data is to be synchronized to multiple sites, the current system has to do a full re-traverse for each site, compare each object's LSD with the LED from the correspondent export record, and identify the modified candidates for each site.

Re-traversing the whole structures and comparing the LED of the export record require a large numbers of database queries. The system response becomes much slower due to the large numbers of database accesses.

In the current PLM customer's environment, data synchronization usually happens nightly, since those processes may take ten hours or more to execute. Synchronization is usually run with the same transaction scope in order to send updates for all such modified objects which are either part of this scope or related to it in a well-defined way.

Disclosed embodiments include techniques to record all data and structures at first time replication, and later, based on the same transaction scope, to execute database queries against recorded replicated information instead of re-traversing the whole structure in order to get the update candidates.

Disclosed embodiments implement a “transaction” concept to represent all data islands that are to be replicated within the scope of that transaction. An “island”, as used herein, a collection of objects which should always be exported as a unit and all of them should have the same ownership across multiple sites. The island generally has one principal object with correspondent children. The transaction information can be inserted into a set of transaction tables, or other data structures, to avoid full re-traverse for the next time a synchronization is executed.

Disclosed embodiments leverage export records to capture site and last export date information so it can accommodate the synchronization among multiple sites.

Execution time of a process as described herein is proportional to the size of the change instead of the size of the structures. It also avoids re-traversing product lifecycle data for each target site requiring synchronization process.

The search scope of finding synchronized candidates can be limited to the replicated data of interest to a user. Customers can then efficiently synchronize only the product lifecycle data and structures that they have the intention to update, instead of the whole database.

Disclosed embodiments include systems and methods for identifying and tracking updates without requiring traversal of the data structure, synchronizing only necessary updates, and can be used to synchronize data to multiple sites. Disclosed techniques can be used, for example, wherever there is a need of identifying incremental updates within a configured product structure. Disclosed techniques can be used with any such object model including but not limited to product structure data such as CAD assembly data, Structure Documents, Manufacturing Process/Plant data, Product Life Cycle data, other PDM data, and otherwise. Disclosed embodiments can efficiently update the specific objects in large structures, such as the Items, Occurrences, Datasets, Attachments, other Attributes, and other objects in a BOM structure or other structure.

Disclosed embodiments implement a traversal-free process that can identify elements of a data structure which could have potentially been modified, within a defined transaction scope, while eliminating with certainty the overwhelming majority of such elements which are guaranteed to have not been modified. This then permits re-examination and re-configuration of this substantially smaller subset of candidate objects, a task which is proportional to the (very small) change and not proportional to the size of the structure itself.

The identification of such candidate objects can include various concepts and constructs described in more detail below. These can include a database trigger mechanism which records any create/delete/update of objects in the database, irrespective of whether or not such objects might be related or relevant to the structure of interest. “transaction scope,” as used herein, refers to the collection of persisted objects (or logical expression of these objects) that correspond to the scope of a transaction. A simple query is then sufficient to identify all objects within the transaction scope for which there was a potential change.

FIG. 1 illustrates a block diagram of a data processing system in which an embodiment can be implemented, for example as a PDM data processing system configured to perform processes as described herein. The data processing system illustrated includes a processor 102 connected to a level two cache/bridge 104, which is connected in turn to a local system bus 106. Local system bus 106 may be, for example, a peripheral component interconnect (PCI) architecture bus. Also connected to local system bus in the illustrated example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example illustrated is audio adapter 124, to which speakers (not illustrated) may be connected for playing sounds. Keyboard/mouse adapter 118 provides a connection for a pointing device (not shown), such as a mouse, trackball, trackpointer, etc.

Those of ordinary skill in the art will appreciate that the hardware illustrated in FIG. 1 may vary for particular implementations. For example, other peripheral devices, such as an optical disk drive and the like, also may be used in addition or in place of the hardware illustrated. The illustrated example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with a plurality of other sites 140a and 140b (or others), which are also not part of data processing system 100, but can be implemented, for example, as a separate data processing systems 100.

Disclosed embodiments describe processes relating to updating and publishing of large data structures. The techniques disclosed herein are particularly useful with BOM structures, and the specific examples described below related to BOM structures, but those of skill in the art will recognize that the disclosed techniques are not limited to BOM structure implementations, and can be applied to elements of other large data structures, not just the structures as described in the examples below.

FIG. 2 illustrates a simplified block diagram of various data structures and relations used in disclosed processes, each of which can be stored in a storage or memory of one or more PDM data processing systems as described herein. Of course, these specific tables and structures are not required in all embodiments, if other structures are used to accomplish the same functions described herein. For example, multiple tables (or other structures) may be used in place of any single table described below.

In this example, the system stores and maintains a data structure 202, which can be a BOM structure, and can store persistent objects 204 that are to be synchronized to one or more other sites. Processing of updated persistent objects 204 on a regular basis is imperative if the users at each site are to work with up-to-date data represented by data structure 202. This must be done without massive re-traversal of the entire structure because otherwise this kind of update operation would not be possible on an hourly or nightly basis, assuming a substantial number of contexts or configurations with a potentially very large number of persistent objects. Because updated persistent objects 204 may need to be updated to multiple sites without excessive overhead, the system can use a scoped transaction-based update process as described herein. The system can also maintain a last saved date (LSD) for each persistent object 204, for example in a persistent objects table.

In order to avoid re-traversal of large structured sets of persisted objects in case only a small number of objects in such a set have changed, disclosed embodiments maintain information related to newly created, modified, and deleted objects, the transaction scope used for specific changes, and the transactions associated with the objects and transaction scope.

The system stores and maintains a scratch table 206 that contains references to any newly created or deleted objects, and can be populated during a database trigger operation which fires when a persisted object is created or deleted. This table is very compact, and can essentially just store the object unique/universal identifier (UID) and a last saved date (LSD) of that object. The LSD can be a very specific timestamp; it is not necessarily as coarse as simply the date.

The system can also store and maintain an export record table 208 that records all objects that were already exported (also referred to as an “export table” or “expt” in the code samples below), and can reflect the state of the structure at the time of the previous export. Consider the following query:

```
  select distinct expt.exp_obj_uid, scratch.puid from %s expt,
  %s pombp, %s scratch
where (expt.state = ‘%d’ and scratch.trigger_condition = ‘%d’)
and (scratch.lsd > expt.led)
and ((expt.exp_obj_uid = pombp.to_uid and scratch.puid =
pombp.from_uid)
or (expt.exp_obj_uid = pombp.from_uid and scratch.puid =
pombp.to_uid))”
```

This exemplary query causes the system to search for all objects in the data structure that are connected to objects in the export record table either by forward or back pointer. The system can thereby enable a user to find any newly created or deleted objects which are connected to objects in the expt table. These can include, for example, newly added Occurrences, added attachments, and other similar new or deleted objects. Further, the system can execute closure rules against any found objects to make sure they are in fact relevant. Modified objects, including but not limited to changed end Items, can be found through export record table and LSD of the persistent object using a separate query.

Since each persistent object replication can be to multiple other sites, the export record table can maintain records of export dates for specific UIDs for each site to which each of them has been exported.

By tracking all of the persisted objects within a given transaction scope, the system can then determine the last saved date of the line from scratch table 206 and perform a simple query to find out which lines have updated. The system can do so by re-using the algorithm outlined above but this time utilizing the last saved dates of each of the objects in the transaction scope.

The system can also take into account any new or deleted objects which, while not yet in the transaction scope, reference an object in the transaction scope. Examples for this are newly added occurrences, attachments, etc.

In PDM system implementations that use “backpointer tables”, i.e., tables keeping track of all forward and backward references between objects, the system can formulate or use additional queries identifying such potential connections by performing a query that has a join with the backpointer table. Such references can then also be filtered further by relevance by analyzing each of the references. Alternatively or additionally, the system can add the objects to the list of candidates and then use processes as described herein to find the update.

The system can therefore create updated and current persistent objects 204, in accordance with any given query, context, or configuration, by using the scratch table 206 and export record table 208 to determine which items from the data structure 202 have been updated, modified, or previously exported, and so can avoid traversing the entire data structure 202.

The system also maintains a Transaction Table 210. Transaction Table 210 maintains records of specific transactions using transaction identifiers (column “Xaction”). The transaction identifiers can be created and used to track such data as the root/principal objections for each transaction, the transaction scope for each transaction, and other data.

In some embodiments, persistent objects for a given transaction scope are recorded in a transaction table 210. When this is the case, the persistent object for the transaction scope can be easily retrieved rather than derived or determined on the fly.

For example, in specific embodiments and for each transaction, the system can maintain data relevant to that transaction, including the unique identifiers the principal object in the island for that transaction (column P.UID). The principal object is typically the root node or parent node for a tree or subtree that represents the island in the structure; subtree table 212 described above can represent the relation between the parent and correspondent children in the tree/subtree structure. The system can also maintain a record of which transaction scope is associated with each transaction (column Scope), and can link to transaction table 210. The system can also maintain a list of the other sites associated with each transaction (column SITES), to which the data for that transaction should be updated. In some cases, the system can also maintain the last process date of each transaction (column LPD), or each site may have a different last process date for each transaction.

Between the export record table and the transaction table, the system maintains the export date of each principal object, and therefore each transaction, to each of the sites to which it has been replicated. Of course, the system could specifically maintain a separate table indicating when each transaction was exported to each site.

Based on a transaction scope and target sites, the system can collect the first-time replicated information and insert the information in the transaction tables based on data islands and principal objects. A database trigger mechanism can be used to record any created and deleted objects in the database. Other embodiments do not require such triggers.

The system can then use simple database queries to gather created, deleted, and modified objects having relation to the first time replicated structures as reflected in the transaction tables. The system can then sync only these objects, limited in scope as defined by the transaction scope, to the other data sites identified in the transaction tables.

The system can also perform a cleanup process to clean the objects inserted by the database trigger after those objects are synchronized.

FIG. 3 illustrates a flowchart of a process in accordance with disclosed embodiments for performing a synchronization in a PDM data processing system. The synchronization process manages persistent objects in a data structure, and can represent, for example, a configured product, part, or assembly and represents only a portion of its entire data structure.

The system can create a transaction for a given set of principal objects in a data structure and a transaction scope to scope the data traversal during the first time replication (step 305). As part of this step, the system determines a plurality of persistent objects for the initial transaction. The transaction scope is defined by these objects and determines the scope of the data to be traversed and replicated, including the principal objects, which are the objects at the root of trees or subtrees in the transaction scope. The corresponding trees or subtrees can be treated as an island of data that should be transferred together. Each of the objects can be associated with a respective unique identifier, and each transaction scope can have a respective transaction identifier. The system can store and maintain the plurality of objects in a transaction table as described herein.

The system creates an entry in a transaction table that identifies elements such as the transaction, the transaction scope, and one or more replication sites for the transaction (step 310). Other data related to the transaction can be included in the entry, including but not limited to the principal object(s).

In various embodiments, given a set of root objects and a transaction scope, the system can collect all dependent objects and group the result into data islands. A transaction identifier can be created to represent a collection of data islands and principal objects. All transaction information can be inserted into the transaction tables.

Note that steps 305 and 310 can be performed once to create the transaction and entry in the transaction table, while the following steps can be performed each time a particular replication transaction is performed.

The system determines the objects to be replicated, within the transaction scope, without fully traversing the data structure (step 315). This step can be based on one or more of a last export date of each persistent object or principal object, the transaction table entry, database triggers, and can identify the update candidates without full re-traverse. This step can include looking up each of the plurality of objects in an export record table stored and maintained by the system. The plurality of objects is identified based on a transaction table entry identifying a specific scoped transaction.

The system determines a last saved date for at least one of the plurality of objects within the transaction scope (step 320). For example, the system can identify any of the objects that have entries in a scratch table stored and maintained by the system as described herein. This step can include monitoring updates and other changes to each of the objects using a trigger mechanism, and storing the last saved date for each such change in the scratch table when the trigger mechanism is activated.

The system compares the last saved date for at least one of the plurality of objects to the last export date of that object or of its associated principal object to determine if the object has been updated/saved since that transaction was last exported, within the transaction scope (step 325). That is, the system can determine specific persistent objects to be updated by comparing a last export date to a last saved date for a principal object corresponding to each site and the specific transaction. For example, the system identifies any object in the transaction scope that has a more recent last-saved-date in the scratch table than the last-export-date in the export record table (the “updated” or “dirty” object). This step can include identifying, for an updated object, a corresponding island of data, based on the object's placement in the data structure and its ancestor principal object, which will typically be the principal object(s) identified by the transaction; the islands(s) may already be identified by the transaction identifier as described above.

Instead of re-traversing the whole structure from the principal object, and comparing the object's LSD with the LED of its correspondent export record, the search for “dirty” islands to be updated is limited to the transaction scope.

Steps 320-325 together describe a high-level process to identify the “dirty” objects and islands to be updated based on which principal objects have been modified since the last replication to a specific site. That is, the system determines specific persistent objects of the plurality of persistent objects to be replicated to each of the plurality of sites based on which of the plurality of persistent objects have been updated since last being replicated to each respective site. In specific embodiments, the system can identify modified dirty principal objects, identify deleted dirty principal objects, and identify created dirty principal objects, as described below. These specific processes can be used to implement steps 320-325 in certain embodiments.

To identify a modified dirty principal object, given a transaction ID and the target site, the system can find modified objects by a single database query of comparing the object's LSD with the LED of the export record of its principal object. The code sample below gives an example of such a process:

```
SELECT DISTINCT exp_obLt.principal_obLuid, exp_obLt.obLuid
FROM EXP_OBJ_TABLE exp_obLt, PIMANEXPORTRECORD IXR,
PPOM_OBJECT P
WHERE IXR.RIXR_TARGET_SITEU = “site1” AND
exp_obj_t.obj_uid = P.puid AND
      P.PLSD> IXR.PIXR_LAST_EXPORT_DATE AND
      exp_obj_t.principal_obj_uid =
      IXR.RIXR_EXPORTED_OBJECTU AND
      exp_obj_t.principal_obj_uid in (
      select principal_obj_uid from
      PRINCIPAL_OBJ_IN_TRANS_TABLE where
      transaction_id = “trans001”)
```

To identify a deleted dirty principal object, given a transaction ID and target site, the system can find deleted objects by a query to find all objects within the given transaction, which also appear in the scratch table with “DELETE” trigger condition, and with the condition of having LSD (last save date) from SCRATCH_TABLE later than the LED of its correspondent principal object's export record. The system can therefore find all deleted objects which haven't been synchronized to the given target site. The code sample below gives an example of such a process:

```
SELECT DISTINCT exp_obj_t.principal_obj_uid, scratch.puid
FROM EXP_OBJ_TABLE exp_obj_t, SCRATCH_TABLE scratch,
      SUBSCRIPTION_TABLE subscription,
      PIMANEXPORTRECORD ixr
WHERE exp_obj_t.principal_obj_uid in (
      select principal_obj_uid
      from PRINCIPAL_OBJ_IN_TRANS_TABLE
      where transaction_id =“trans001”) AND
      exp_obj_t.obj_uid =scratch.puid AND
      scratch.trigger_condition =
      “TIETriggerStatus_TRIGGER_DELETE” AND
      scratch.lsd> ixr.PIXR_LAST_EXPORT_DATE AND
      exp_obj_t.principal_obj_uid =IXR.rixr_exported_objectu AND
      IXR.RIXR_TARGET_SITEU = “site1”
```

To identify a newly created dirty principal object, given a transaction ID, the system can find created objects by finding objects in the SCRATCH_TABLE with an “ADD” trigger condition which have immediate relevance (using back pointer table) to objects inside the original transaction. After getting first level created objects, they will be passed to the traverse engine, and get all created underneath objects based on the transaction scope of this transaction, then grouping the result by data islands. The code sample below gives an example of such a process:

| | |
|---|---|
| SELECT | DISTINCT exp_obLt.principal_obLuid, scratch.puid |
| FROM | EXP_OBJ_TABLE exp_ob_t, SCRATCH_TABLE |
| | scratch, POM_BACKPOINTER backp, |
| | EXPORT_TO_SITE_TABLE expt |
| WHERE | scratch.lsd > expt.lpd AND expt.site_id =siteid AND |
| | scratch.trigger_condition = |
| | TIETriggerStatus_TRIGGER_ADD AND |
| | exp_ob_t.principaLobj_uid in ( |
| | select principal_obj_uid |
| | from PRINCIPAL_OBJ_IN_TRANS_TABLE |
| | where transaction_id =“trans001) AND |
| | ((exp_obj_t.obLuid =backp.from_uid AND scratch.puid = |
| | backp.to_uid) OR (exp_obj_t.obLuid =backp.to_uid |
| | AND scratch.puid =backp.from_uid)) |

The system can initiate a synchronization transaction according to identified updated persistent objects, without traversing the entire data structure (step 330). This can include retrieving from the data structure only those specific objects that have been updated or saved since they were last exported.

The system can perform the synchronization transaction to replicate the updated persistent objects according to the transaction scope, without fully traversing the data structure, to one or more of the sites identified by the transaction (step 335). This can include replicating only the updated objects identified by the transaction scope or replicating only the island(s) of data for updated objects. This step can include or be followed by cleaning up the scratch table or other tables.

In some specific embodiments, after created/deleted/modified principal objects have been identified, only those dirty principal objects will be processed for replication, and all children within the dirty islands will be replicated to the target sites. Successfully synchronized objects will be removed from the scratch tables and other tables. In various embodiments, the system can maintain a subtree table 212 that associates each child object (Child.UID) with its parent object (Parent.UID).

For example, if the system synchronizes the data to site1 on date5, it will then update the last process date from date1 to date5. The system can update its records with the earliest process date for the given transaction. This can be accomplished using a “last process date” (LPD) function. For example, a function min LPD (date5, date2) will get date2. By using the earliest last process date of the given transaction, the system guarantees that all created/deleted objects in the scratch table will not be removed until they are synchronized to all target sites.

In this example, the system can then remove all entries from the scratch table having LSD earlier than the last processed date from its records. If the removed object has the “DELETE” trigger condition, the object can be also removed from the export record table. If the object has “ADD” trigger condition, for the created object, it will be inserted into the correspondent transaction entries immediately. Once the created objects are inserted into the sync transaction tables, for the next target site performing synchronization, created objects can be identified by the query of finding modified dirty islands using the logic of export record comparison. However, for the deleted object, it will not be removed from the transaction entry until all target sites get synchronized.

In various embodiments described above, in order to find the created/deleted objects, the system uses DELETE and ADD condition triggers to record when “every” object gets created or deleted in the scratch table no matter whether or not the object has relation to the transaction. Although the process above can clean up the scratch table, the table might still have a chance of getting bigger before clean up, causing some performance issue of querying large amount of data in the scratch table.

Other embodiments can perform a similar process that does not require the scratch table or database triggers.

The system can identify newly created objects related to the transaction without using triggers and the scratch table. If the created object has the reference to the object, or is referenced by the object inside the transaction, the back pointer table should have the entry to connect them together. Queries can be formed to select the first level created objects referencing to objects inside the transaction, comparing the LSD of created objects with the LED of its correspondent principal object's export record. The first level created objects can be used as input to the replication process to get all created objects underneath.

Joining a backpointer table and the principal objects can be a time consuming activity in some cases, but in these cases using a sub query instead of table joining can enhance the performance.

The system can identify deleted objects related to the transaction without using triggers and the scratch table. To do so, the system can first find all objects in the transaction that are no longer listed as persistent objects. This means those objects are deleted. The system can then use the date of performing synchronization as the object deletion date. The system can then synchronize the dirty deleted islands to the target site, and update the last process date. When performing cleanup, the system can then find the earliest LPD (date3, date2), and remove entries from export record table which have deletion date earlier than the minimum LPD from export record table. This means all delete objects are already synchronized to all target sites for all transactions.

In contrast to previous approaches, where an accountability table is used to store all objects ever transferred, processes described herein only store information on subsets of objects in an export record table. These subsets, described above as the islands of data principal objects, are limited to the transaction scope.

Other approaches do not scope transactions as described herein, and only provide updates within site consolidation scope and only to a single specific database. Processes as described herein can be performed according to the transaction scope and can manage many target databases.

Processes as described herein also maintain export records that capture site and export date information. Disclosed processes also include an alternative implementation of not using triggers.

For synchronizing created objects, disclosed techniques can identify all underneath created objects appended to structures within the existing transaction. Previous approaches only identified the created objects having immediate reference to objects in the transaction.

Those skilled in the art will recognize that, for simplicity and clarity, the full structure and operation of all data processing systems suitable for use with the present disclosure is not being illustrated or described herein. Instead, only so much of a data processing system as is unique to the present disclosure or necessary for an understanding of the present disclosure is illustrated and described. The remainder of the construction and operation of data processing system 100 may conform to any of the various current implementations and practices known in the art. Various steps, processes, and components can be omitted, replaced, or rearranged in accordance with various embodiments, and should not be considered essential to any specific embodiment unless specifically claimed below.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method performed by a product data management (PDM) data processing system, comprising:
determining, by the PDM data processing system, a plurality of persistent objects in a data structure to be replicated to a plurality of replication sites, wherein the plurality of persistent objects is identified based on a transaction table entry identifying a specific scoped transaction;
determining specific persistent objects of the plurality of persistent objects to be replicated to each of the plurality of replication sites based on which of the plurality of persistent objects have been updated since last being replicated to each respective replication site, without traversing the full data structure;
initiating a synchronization transaction according to the specific persistent objects; and
replicating the specific persistent objects to at least one of the plurality of replication sites, without traversing the full data structure.

2. The method of claim 1, wherein the specific persistent objects are determined by comparing a last export date to a last saved date for a principal object corresponding to each replication site and the specific transaction.

3. The method of claim 1, wherein the PDM data processing system stores a plurality of objects for each of a plurality of transactions in a transaction table.

4. The method of claim 1, wherein the PDM data processing system maintains a transaction table that identifies a plurality of transaction entries and at least one of the plurality of replication sites for each of a plurality of transaction entries.

5. The method of claim 1, wherein the PDM data processing system, during a first time replication, creates a transaction for a given set of principal objects in the data structure and a transaction scope that defines a scope of the data traversal for the transaction.

6. The method of claim 5, wherein the PDM data processing system creates the transaction table entry based on the transaction that identifies the transaction, the principal objects, and one or more replication sites for the transaction.

7. The method of claim 5, wherein the PDM data processing system also collects a plurality of dependent objects corresponding to each of the principal objects and groups the dependent objects into data islands.

8. A product data management (PDM) data processing system comprising:
a processor; and
an accessible memory, the data processing system particularly configured to
determine a plurality of persistent objects in a data structure to be replicated to a plurality of replication sites, wherein the plurality of persistent objects is identified based on a transaction table entry identifying a specific scoped transaction;
determine specific persistent objects of the plurality of persistent objects to be replicated to each of the plurality of replication sites based on which of the plurality of persistent objects have been updated since last being replicated to each respective replication site, without traversing the full data structure;
initiate a synchronization transaction according to the specific persistent objects; and
replicate the specific persistent objects to at least one of the plurality of replication sites, without traversing the full data structure.

9. The PDM data processing system of claim 8, wherein the specific persistent objects are determined by comparing a last export date to a last saved date for a principal object corresponding to each replication site and the specific transaction.

10. The PDM data processing system of claim 8, wherein the PDM data processing system stores a plurality of objects for each of a plurality of transactions in a transaction table.

11. The PDM data processing system of claim 8, wherein the PDM data processing system maintains a transaction table that identifies a plurality of transaction entries and at least one of the plurality of replication sites for each of a plurality of transaction entries.

12. The PDM data processing system of claim 8, wherein the PDM data processing system, during a first time replication, creates a transaction for a given set of principal objects in the data structure and a transaction scope that defines a scope of the data traversal for the transaction.

13. The PDM data processing system of claim 12, wherein the PDM data processing system creates the transaction table entry based on the transaction that identifies the transaction, the principal objects, and one or more replication sites for the transaction.

14. The PDM data processing system of claim 12, wherein the PDM data processing system also collects a plurality of dependent objects corresponding to each of the principal objects and groups the dependent objects into data islands.

15. A non-transitory computer-readable storage medium encoded with computer-executable instructions that, when executed, cause a product data management (PDM) data processing system to:
determine a plurality of persistent objects in a data structure to be replicated to a plurality of replication sites, wherein the plurality of persistent objects is identified based on a transaction table entry identifying a specific scoped transaction;
determine specific persistent objects of the plurality of persistent objects to be replicated to each of the plurality of replication sites based on which of the plurality of persistent objects have been updated since last being replicated to each respective replication site, without traversing the full data structure;
initiate a synchronization transaction according to the specific persistent objects; and
replicate the specific persistent objects to at least one of the plurality of replication sites, without traversing the full data structure.

16. The computer-readable storage medium of claim 15, wherein the specific persistent objects are determined by comparing a last export date to a last saved date for a principal object corresponding to each replication site and the specific transaction.

17. The computer-readable storage medium of claim 15, wherein the PDM data processing system stores a plurality of objects for each of a plurality of transactions in a transaction table.

18. The computer-readable storage medium of claim 15, wherein the PDM data processing system maintains a transaction table that identifies a plurality of transaction entries and at least one of the plurality of replication sites for each of a plurality of transaction entries.

19. The computer-readable storage medium of claim 15, wherein the PDM data processing system, during a first time replication, creates a transaction for a given set of principal objects in the data structure and a transaction scope that defines a scope of the data traversal for the transaction.

20. The computer-readable storage medium of claim 19, wherein the PDM data processing system creates the transaction table entry based on the transaction that identifies the transaction, the principal objects, and one or more replication sites for the transaction and also collects a plurality of dependent objects corresponding to each of the principal objects and groups the dependent objects into data islands.
